(19) United States
(12) Patent Application Publication
(10) Pub. No.: US 2021/0355805 A1
(43) Pub. Date: Nov. 18, 2021

(54) AI/ML BASED DRILLING AND PRODUCTION PLATFORM

(71) Applicant: Landmark Graphics Corporation, Houston, TX (US)

(72) Inventors: Keshava Prasad Rangarajan, Sugarland, TX (US); Raja Vikram R. Pandya, Katy, TX (US); Srinath Madasu, Houston, TX (US); Shashi Dande, Spring, TX (US)

(21) Appl. No.: 16/651,859

(22) PCT Filed: Dec. 5, 2019
(86) PCT No.: PCT/US2019/064655

§ 371 Date: Mar. 27, 2020

Related U.S. Application Data
(60) Provisional application No. 62/891,223, filed on Aug. 23, 2019.

(51) Int. Cl. E21B 44/00; E21B 49/00; E21B 7/06; G06N 5/02; G06N 20/00; G01V 99/00

(52) U.S. Cl. CPC E21B 44/00; E21B 49/003; E21B 7/064; G06N 5/02; E21B 47/005; G01V 99/005; E21B 2200/20; E21B 2200/22; G06N 20/00

(57) ABSTRACT

A system for controlling operations of a drill in a well environment. The system comprises a predictive engine, a ML engine, a controller, and a secure, distributed storage network. The predictive engine receives a variables associated with surface and sub-surface sensors and predicts an earth model based on the variables, predictor variable(s), outcome variable(s), and relationships between the predictor variable(s) and the outcome variable(s). The predictive engine is also configured to predict a drill path(s) ahead of the drill based on using stochastic modeling, an outcome variable(s), the predicted earth model, and a drilling model(s). The controller is configured to generate a system response(s) based on the predicted drill path(s) and a current state of the drill. The ML engine stores the earth model, the drill path(s), and the variables in the distributed storage network, trains data, and creates the drilling model(s).

### BACKGROUND

Artificial Intelligent (AI) and Machine Learning (ML) are promising technologies that can be used to improve traditional methods and practices of various industries. Technologies developed therefrom are in general developed and used to create new machinery and improve a machine's performance, e.g. precision control and diagnostics. The advantages of each can spawn new industries, improve product development, and create safer work environments. Blockchain is a promising technology that can be used to manage data using a distributed, secure network architecture. Data stored in a blockchain cannot be easily compromised. Therefore, data that is considered sensitive can be securely stored in a blockchain which can prevent the corruption and unauthorized access thereto.

### BRIEF DESCRIPTION OF THE DRAWINGS

For a more complete understanding of the features and advantages of the present disclosure, reference is now made to the detailed description along with the accompanying figures in which corresponding numerals in the different figures refer to corresponding parts and in which:

FIG. 1 is an illustration of a diagram of a system stack for controlling drilling and production operations of a well environment, in accordance with certain example embodiments;

FIG. 2 is an illustration is an architectural diagram of a system for controlling drilling and production operations of a well environment, in accordance with certain example embodiments;

FIGS. 3A-3C are illustrations of diagrams of a pattern recognition component of a predictive engine that comprises an AI engine, a pattern recognition component of a predictive engine that comprises the AI engine and an ML engine, and a visualization generated therefrom, in accordance with certain example embodiments;

FIG. 4 is an illustration of a flow diagram of an algorithm for a predictive engine, in accordance with certain example embodiments; and

FIG. 5 is an illustration of a computing machine and a system applications module, in accordance with certain example embodiments.

### DETAILED DESCRIPTION

While the making and using of various embodiments of the present disclosure are discussed in detail below, it should be appreciated that the present disclosure provides many applicable inventive concepts, which can be embodied in a wide variety of specific contexts. The specific embodiments discussed herein are merely illustrative and do not delimit the scope of the present disclosure. In the interest of clarity, not all features of an actual implementation may be described in the present disclosure. It will of course be appreciated that in the development of any such actual embodiment, numerous implementation-specific decisions must be made to achieve the developer's specific goals, such as compliance with system-related and business-related constraints, which will vary from one implementation to another. Moreover, it will be appreciated that such a development effort might be complex and time-consuming but would be a routine undertaking for those of ordinary skill in the art having the benefit of this disclosure.

Presented herein are a system, a method, and an apparatus for controlling drilling and production operations of a well environment. In an embodiment, the system, the method, and the apparatus are configured to predict earth models and optimal drilling paths using AI algorithms and create drilling models using ML algorithms. As is discussed below in more detail, the models are predicted using various predictor variables, outcome variables, and relationships between the predictor variables and the outcome variables. The variables are created from different sources, such as surface sensors, sub-surface sensors, and user input. The optimal drill paths are predicted based on stochastic modeling, outcome variables, predicted earth models, and drilling models.

In this specification, artificial intelligence means and algorithm that can create a data model based on relationships between variables, the strength of relationships, and interactions between variables. Bayesian Optimization is an optimization algorithm. Multi-objective means an optimization case/situation where more than one interrelated objective functions need to be optimized. Bayesian optimization used for multi-objective situation is referred to as multi-objective Bayesian optimization. Machine learning means a statistical algorithm that can train data to create a learned data model based on historical variables, and the training thereof, and modify and update the data model based on newly obtained single or multiple observations. Data model means a set of variables selected from a data source based on predictor variables, outcome variables, and relationship, i.e. strength of relationship between variables. Strength of relationship can be between predictor variables and outcome variables. Predictor variables are variables used to predict an outcome. Outcome variables are variables in which their value is dependent on a predictor variable or predictor variables. Feature selection means an algorithm that can identify and select variables within a data source that contribute to the predictor variables and outcome variables. Variable interaction means that the contribution of one predictor variable is modified by one or many other predictor variables, so that the combined contribution of all variables involved in the interaction is greater than the simple sum over the individual contributions attributable to each variable. An earth model defines the spatial distribution of sub-surface properties such as permeability, porosity, faults, salt bodies, etc. Typical variables in a drilling models can include, and without limitation, weight on bit, rotations per minute of the drill bit, mud flow rate, differential pressure of the mud-motor, stand pipe pressure.

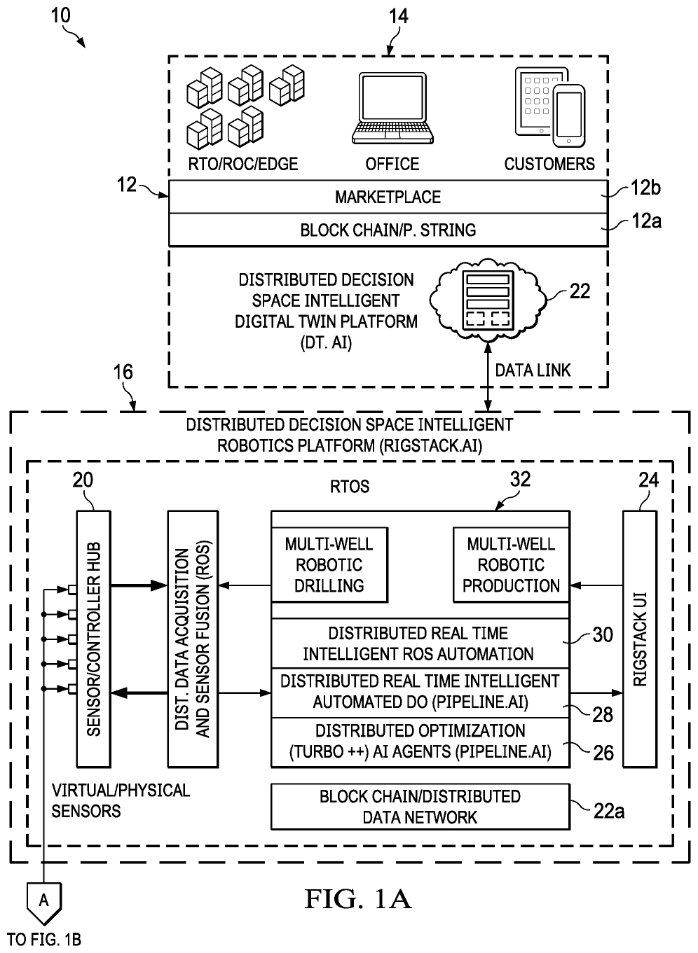

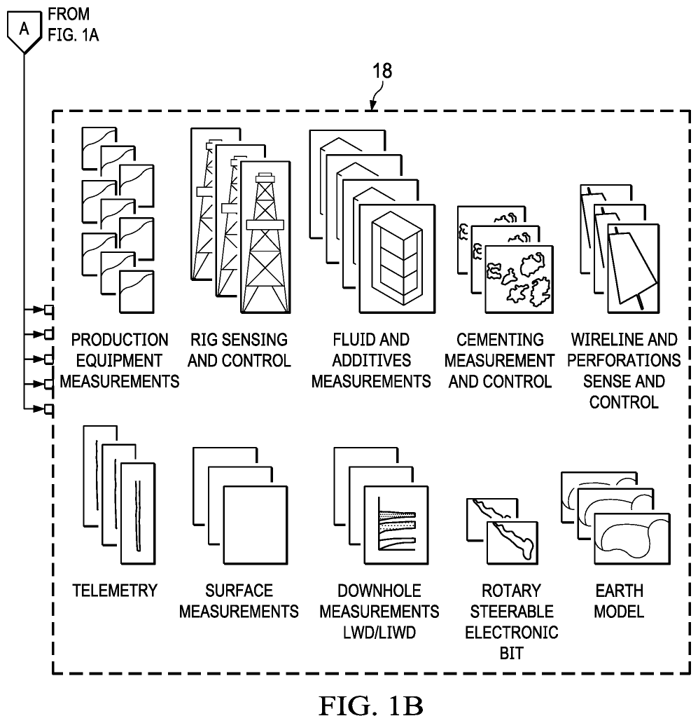

Referring now to FIG. 1, illustrated is a diagram of a system stack for controlling drilling and production operations of a well environment, in accordance with example embodiments, denoted general as 10. The term stack is used herein to describe various software components of a system architecture and does not necessarily mean any specific series, i.e. a particular path, of processing or communications. The system stack 10 comprises an access point component 12, a plurality of device components 14, a system controller component 16, and field device components 18. The system stack 10 can be used to predict optimal drilling paths, created data models, create visualizations, control drilling operations, control production operations, and store data models within a secure, distributed manner.

The access point component 12 is a network access point that allows for device components 14, authenticated and authorized, to securely communicate with the system controller component 16. The system controller component 16 can comprise a sensor/controller hub component 20, a distributed storage platform 22, and a predictive and visualization engine 24. The sensor hub component 20 can comprise an interface or multiple interfaces to communicate data to and from the field devices components 18. The sensor/controller hub component 20 and the distributed storage platform 22 are communicable coupled using a distributed data acquisition and sensor fusion interface.

The distributed storage platform 22 can be, for example, a block chain application used to process and store data securely within a distributed storage environment using a peer-to-peer network and Public Key Infrastructure (PKI) cryptography. The distributed storage platform 22 can also be a distributed database application, e.g. common applications used in big data platforms and cloud computing platforms, used to process and store data securely within a distributed storage environment. The distributed storage platform 22 can be a combination of a block chain application and a distributed database application. The data stored in the distributed storage environment can include, and without limitation, optimization variables 26, data models, and sensor and control variables 28, 30. The variables can be partitioned into drilling and production variables 32. In an embodiment, data provenance and data security are preserved by the use of block chain so that data integrity is preserved. A digital twin or a subset of the data can be stored in the cloud so that AI/ML algorithms can be executed more efficiently.

The device components 14 can include different types of device components, such as server(s), router(s), clients(s), and combinations thereof, which can communicate with the access point component 12, e.g. using a proper network communications technique and secure communications method. In an embodiment, the device components 14 can be configured to communicate with the system controller stack 16 using either a block chain and/or distributed data application 12a and/or a services access application 12b, such as communications access to data models, predictive engines, and visualization engines, and variable data associated with the engines.

The field device components 18 can be communicable coupled with the sensor hub component 20 and can include a plurality of variables used to control drilling and production operations. The variables in general are generated from surface and sub-surface devices and can include, and without limitation, current drilling coordinates, production equipment measurements, rig sensing and control, fluids and additive measurements, cementing measurement and control, wireline and perforations sense and control, telemetry, surface measurements, downhole measurements, rotary steerable electronic bit, and earth physical properties data. These variables, at one time or another, can be stored and processed in the system stack 10 and some, at least in part, can be generated from the field device components 18, distributed storage platform 22, predictive engine, and visualization engine and used thereby.

The system stack is designed to operate in different modes for different purposes. These different modes are manual offline mode, manual online mode, autonomous offline mode, autonomous online mode, semi-auto offline mode, and semi-auto online mode.

In manual offline mode, a simulator system utilizes historical data and/or physics and data based models. In this mode, simulator system can be utilized for following purposes: i) training drillers; ii) generating data and training artificial intelligence (AI) and machine learning based various models required for drilling automation; and ii) Testing various scenarios of drilling and generating sequences of commands for drilling automation. In manual online mode, expert drillers control the drilling system through the system stack. In this mode, the system stack can be utilized for real time data collection and training and refinement of AI based controllers and models for drilling automation. In autonomous offline mode, the system stack utilizes information used and generated in the manual offline mode and manual online mode and various autonomous simulation runs are performed. The system stack can also generate data and train and refine AI based controllers and models for drilling automation. In autonomous online mode, the system stack utilizes information generated in the first three modes and any other required information and performs all operation in automatic mode. System stack can also collects real time data and train and refine various AI and machine learning based models. The semi-auto offline mode is a combination of the first and third modes. In this mode, expert drillers can interfere with the system stack to provide feedback and modify process as needed when the system is in autonomous offline mode. Semi-auto online mode is a combination of the second and fourth (manual online mode and autonomous online mode). In this mode, expert drillers can interfere with the system stack to provide feedback and modify processes as needed when the system stack is in autonomous online mode.

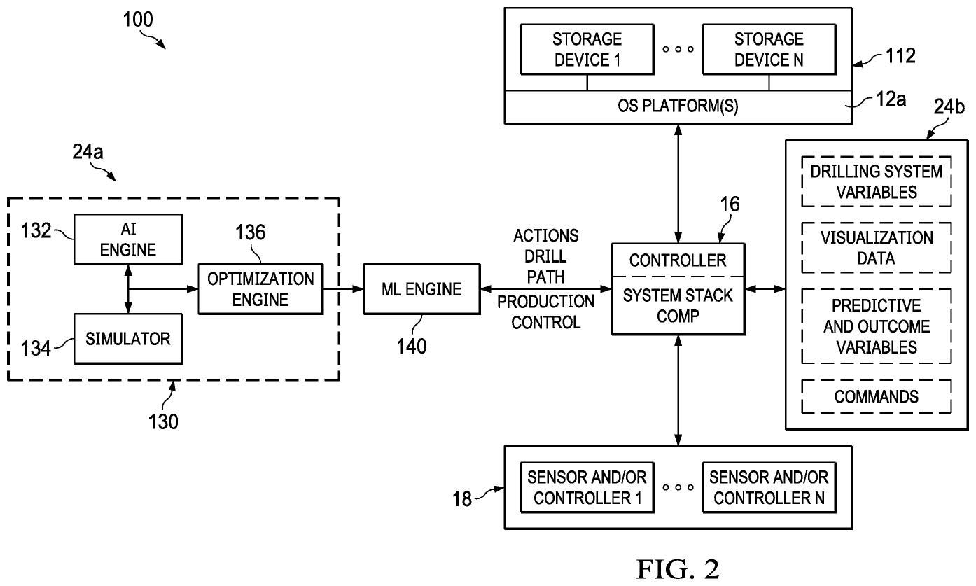

Referring now to FIG. 2, illustrated is an architectural diagram of a system for controlling drilling and production operations of a well environment, in accordance with example embodiments, denoted generally as 100. The system 100 comprises the predictive engine 24a and visualization engine 24b. The predictive and visualization engine 24a, 24b are communicable coupled to a plurality of storage devices 112 and the plurality of field device components 18 through the system controller component 16 and the distributed data application 12a. The system 100 can be used to generate optimal drilling paths and optimal production control variables based on relevant data models, various AI algorithms, and ML algorithms. The drilling patterns can be generated for consumer consumption to assist in and improved performance of drilling and production operations and/or the automation and improved performance, i.e. control and accuracy, of drilling and production equipment.

The predictive engine 24a can comprise a drill path and production control pattern recognition component 130 and an ML engine 140. The pattern recognition component 130 can comprise an AI engine 132, a simulator 134, and an optimization engine 136. In an embodiment, the AI engine 132 can predict an earth model based on well log and seismic data variables collected from field device components 18, other input data, an AI algorithm.

The well log data variables and seismic data variables can include current drilling coordinates, production equipment measurements, rig sensing and control, fluids and additive measurements, cementing measurements and controls, wireline and perforations sense and control, telemetry, surface measurements, downhole measurements, rotary steerable electronic bit, and earth physical properties data. The other data can include initial realizations from well planning variables and Subject Matter Expert (SME) variables. The accuracy of the generated earth model is assessed using a simulator 134. For example, the accuracy of the generated model can be assessed based on a reservoir fracking or reservoir production simulation. In essence, historical data and trained data can be used to assess whether the generated model can be determined to be reliable based on past historical models and operations. Using the aforementioned variables, the results of the simulator 134, and the AI algorithm, an earth model beyond a current location of a downhole drill bit can be predicted. Examples of AI algorithms that can be used include, without limitation, Neural Network, Randomforest, Gradient boosting etc.

The optimization engine 136 can generate a drill path or production control variable or variables using statistics based pattern recognition, such as using stochastic modeling techniques, and the generated earth model. The drill path can be a set of variables defining sub-surface, earth coordinates. Based on the generated drill path, actions can also be generated describing what corrective actions or manipulations of equipment are needed in order to create an optimal drill path. The production control variables can be a set of variables used to control a valve or a pump.

The ML engine 140 can record the earth model and the drill path and production control variable(s) along with other variables in the plurality of storage devices 112. After enough data is stored, the ML engine 140 can create data models, used by an AI algorithm, by training the stored variables using a learning algorithm. Based on received sensor data from the field device components 18, the trained data, and the use of known AI algorithms, an optimal drill path can be determined.

The visualization engine 24b can be used to display the generated drill path and production control variables and actions along with other relevant data. The visualization engine 24b can display the generated drill path and production control variables and actions in real-time or near real-time and can display the drill paths and production variables in graphs, charts, or any other type of visualization typically used in visualization platforms. The visualization engine 24b is also configured to retrieve drill paths from the storage devices 112. In an embodiment, a user or consumer can define the predictive and outcome variables used to generate the drill path variables. In another embodiment, the predictive and outcome variables can be predefined, e.g. using a-prior models, drill, and production control variables. The user also can issue commands in order to change or adjust the actions and drill path based on other information, e.g. information from a SME.

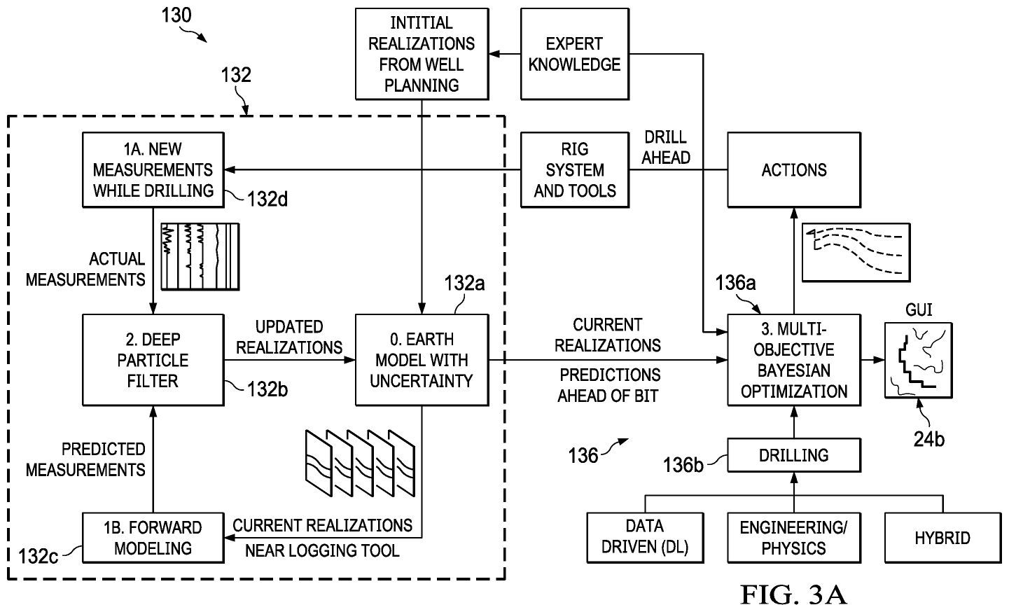

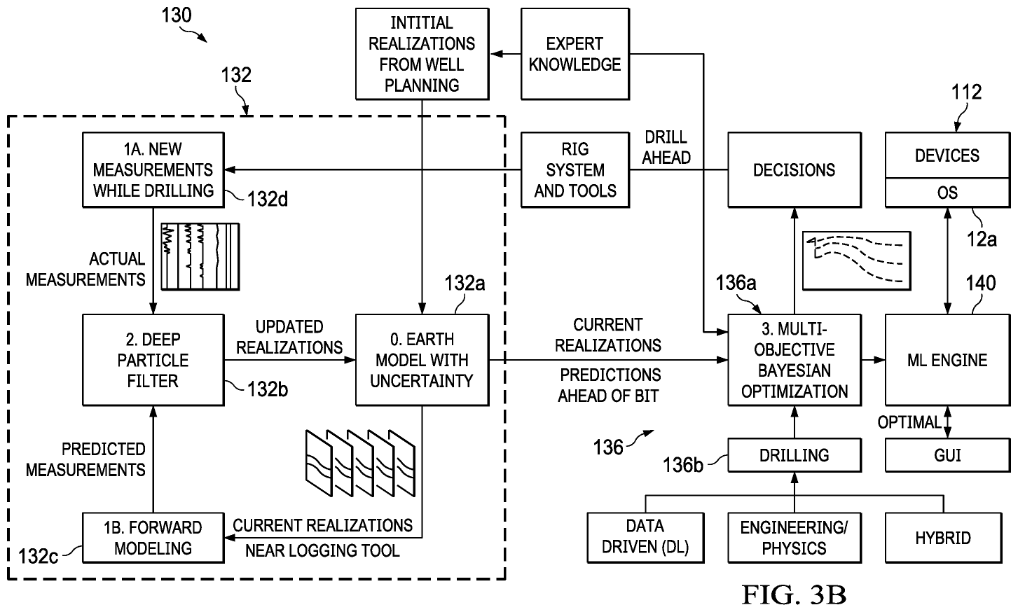

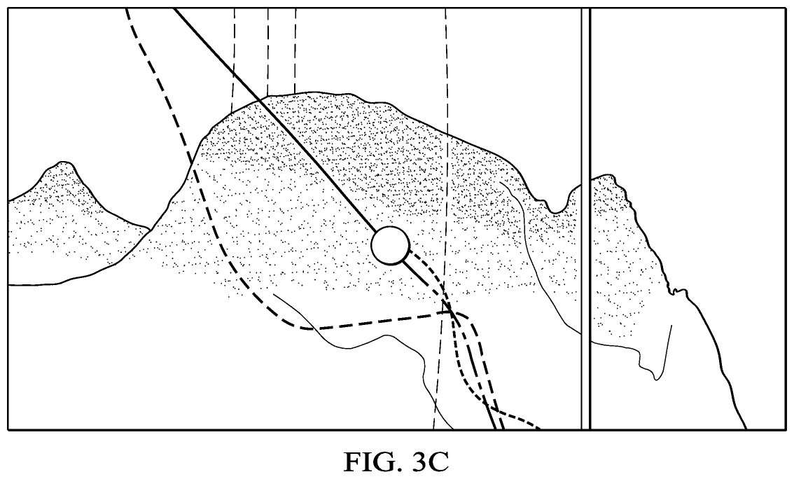

Referring now to FIGS. 3A-3C, illustrated are diagrams of the pattern recognition component 130 that comprises the AI engine 132 and the pattern recognition component 130 that comprises the AI engine 132 and ML engine 140, and a visualization generated therefrom, in accordance with example embodiments. In one embodiment, an earth model can be predicted. The earth model is predicted based on sensor measurement data and other data, such as well planning and SME data, using known AI algorithms. The earth model can comprise logical columns of data defining parameters and values for earth physical properties and coordinates. The earth model can be used to sample against trained models to determine an optimal drill path(s) or production control variable(s). In another other embodiment, the earth model is predicted, the optimal drill path(s) or production control variable(s) are determined, and models, e.g. drilling, are trained. In the first embodiment, the trained data models are provided by a third party and, in the second embodiment, the third party creates the trained models. The trained models, e.g., can be accessed from the distributed storage platform 22.

As used herein, an earth model comprises predictor variables that can come from field measurements from the field device components 18 or predictor variables that can come from field measurements from the field device components 18 and user input, such SME input. Trained models can refer to ML based drill paths or production control variables based on a-prior predictor variables and a-priori outcome variables. Outcome variables can be obtained from well planning data, such as geological surveys, and SME knowledge.

In FIG. 3A, the pattern recognition component 130 comprises the AI engine 132 coupled with the visualization engine 24b. The AI engine 132 is configured to predict and generate an earth model 132a that predicts relevant earth coordinates and physical properties ahead of a drill bit during drilling based on well log data and/or seismic data from field device components 18. In an embodiment, the measurement variables received from the field device components 18, such as from surface and down hole sensors, identify current state of a drilling or production operation. This state information can include without limitation: drilling coordinates, production equipment measurements, rig sensing and control, fluids and additive measurements, cementing measurements and controls, wireline and perforations sense and control, telemetry, surface measurements, downhole measurements, rotary steerable electronic bit, and earth physical properties data. Since communication of this type of data from a downhole environment can result in corruption of the variables, the AI engine 132 can use a data filter component 132b, e.g. a deep particle filter known in the industry, to clean the data prior to generating the earth model. In addition, the AI engine 132 can use a forward modeling component 132c to compare predicted variables in the earth model to the measured or measured and cleaned variables in the predicted earth model 132a.

The optimization engine 136 comprises an optimization tool 136a and a drilling model or models 136b from which to sample from based on the generated earth model 132a. In an embodiment, the optimization tool 136a is a multi-objective Bayesian optimization tool. Other optimization tools include, and without limitation, genetic algorithm optimization and particle swarm optimization. The predictive engine 24 can generate a drill path(s) or production variables based on the output of the optimization tool 136a. The predictive engine 24 can generate a drill path(s) or production variables based on the output of the optimization tool 136a.

In FIG. 3B, the pattern recognition component 130 comprises the AI engine 132 and the ML engine 140 coupled with the visualization engine 24b. The AI engine 132 is configured to predict and generate an earth model 132a that predicts relevant earth coordinates and physical properties ahead of a drill bit during drilling based on well log data and/or seismic data from field device components 18. In an embodiment, the measurement variables received from the field device components 18, such as from surface and down hole sensors, identify current state of a drilling or production operation. This state information can include without limitation: drilling coordinates, production equipment measurements, rig sensing and control, fluids and additive measurements, cementing measurements and controls, wireline and perforations sense and control, telemetry, surface measurements, downhole measurements, rotary steerable electronic bit, and earth physical properties data. Since communication of this type of data from a downhole environment can result in corruption of the variables, the AI engine 132 can use a data filter component 132b, e.g. a deep particle filter known in the industry, to clean the data prior to generating the earth model. In addition, the AI engine 132 can use a forward modeling component 132c to compare predicted variables in the earth model to the measured or measured and cleaned variables in the predicted earth model 132a.

The optimization engine 136 comprises an optimization tool 136a and a drilling model or models 136b from which to sample from based on the generated earth model 132a. In an embodiment, the optimization tool 136a is a multi-objective Bayesian optimization tool. The predictive engine 24 can generate a drill path(s) or production variables based on the output of the optimization tool 136a. The predictive engine 24 can generate a drill path(s) or production variables based on the output of the optimization tool 136a. In this embodiment, the ML engine 140 is used to store drill path variables, production control variables, earth model (predictor variables), outcome variable(s), and an objective function or functions in the storage devices 112 as training data. Over time, the ML engine 140 can create the drilling model(s) 136b by incrementally training the data using an ML learning algorithm. FIG. 3C illustrates a visualization of a distribution of plausible paths that avoid obstacles. The sphere is a representation of a dill bit and it follows an optimal path defined by the converging lines after the waypoint (where the lines intersect). The other deviating line after the waypoint is an initial optimal path but based on updated measurement variables became a less efficient path.

The generated earth model 132a comprises logical columns of predictor variables that identify a future state of a drilling and production operation. This state information can include: drilling coordinates, production equipment measurements, rig sensing and control, fluids and additive measurements, cementing measurements and controls, wireline and perforations sense and control, telemetry, surface measurements, downhole measurements, rotary steerable electronic bit, and earth physical properties data.

The multi-objective Bayesian optimization tool samples from the drilling models 136b to identify an optimal outcome variable in the form of a drill path, e.g., based on multiple objectives, i.e. other outcome variables. As an example, the objectives can be, and without limitation, path length (user requires it to be minimum), drilling time (user requires it to be minimum), curvature (user requires it to be minimum) drilling cost (user requires it to be minimum), mud loss (user requires it to be minimum). All these objectives are interrelated which means that minimum values of all these objectives for a single path cannot be achieved. For example, shortest path between start and end points is a straight line. However, this path may not be feasible to drill or it passes through region where rate of penetration is low and can lead to higher value for drilling time as compared to other path. So depending on the subsurface information, a user has to make a compromise for optimum values of interrelated objective functions while selecting optimum drill path from various possible drill paths.

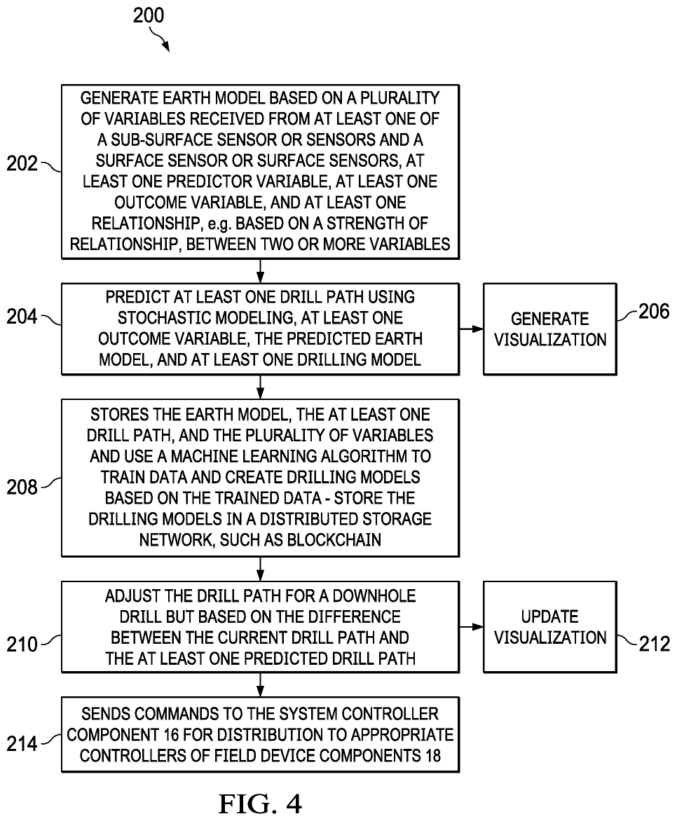

Referring now to FIG. 4, illustrated is a flow diagram of an algorithm for a predictive engine, in accordance with example embodiments, denoted generally as 200. The algorithm 200 begins at block 202. An earth model is generated based on a plurality of variables received from at least one of a sub-surface sensor or sensors and a surface sensor or surface sensors, at least one predictor variable, at least one outcome variable, and at least one relationship, e.g. based on a strength of relationship, between two or more variables. At block 204, the algorithm 200 predicts at least one drill path using stochastic modeling, at least one outcome variable, the predicted earth model, and at least one drilling model. In response to the predicted drill path, the algorithm 200 can generate a visualization, block 206. At block 208, the algorithm 200 stores the earth model, the at least one drill path, and the plurality of variables and use a machine learning algorithm to train data and create drilling models based on the trained data. The algorithm 200 can store at least one of the earth model, the at least one drill path, the plurality of variables, and the drilling models in a distributed storage network, e.g. as entries in a blockchain database system. At block 210, the drill path for a downhole drill bit is adjusted based on the difference between the current drill path and the at least one predicted drill path. In embodiment, the drill path can be adjusted when the difference between the current drill path and the at least one predicted drill path exceeds a predetermined threshold. At block 212, the algorithm 200 can updated the generated visualization. At block 214, the algorithm 200 sends commands to the system controller component 16 for distribution to appropriate controllers of field device components 18.

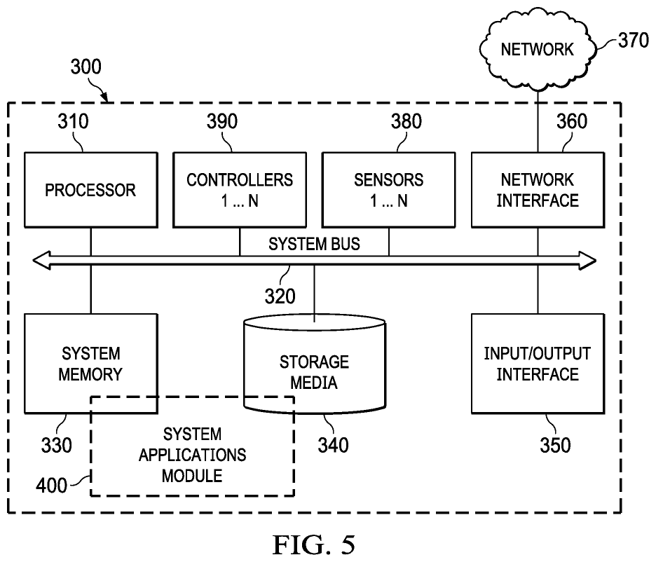

Referring now to FIG. 5, illustrated is a computing machine 300 and a system applications module 400, in accordance with example embodiments. The computing machine 300 can correspond to any of the various computers, mobile devices, laptop computers, servers, embedded systems, or computing systems presented herein. The module 300 can comprise one or more hardware or software elements, e.g. other OS application and user and kernel space applications, designed to facilitate the computing machine 300 in performing the various methods and processing functions presented herein. The computing machine 300 can include various internal or attached components such as a processor 310, system bus 320, system memory 330, storage media 340, input/output interface 350, a network interface 360 for communicating with a network 370, e.g. a loopback, local network, wide-area network, cellular/GPS, Bluetooth, WIFI, and WIMAX, and sensors 380, and controllers 390.

The computing machine 300 can be implemented as a conventional computer system, an embedded controller, a laptop, a server, a mobile device, a smartphone, a wearable computer, a customized machine, any other hardware platform, or any combination or multiplicity thereof. The computing machine 300 and associated logic and modules can be a distributed system configured to function using multiple computing machines interconnected via a data network and/or bus system.

The processor 310 can be designed to execute code instructions in order to perform the operations and functionality described herein, manage request flow and address mappings, and to perform calculations and generate commands. The processor 310 can be configured to monitor and control the operation of the components in the computing machines. The processor 310 can be a general purpose processor, a processor core, a multiprocessor, a reconfigurable processor, a microcontroller, a digital signal processor (“DSP”), an application specific integrated circuit (“ASIC”), a controller, a state machine, gated logic, discrete hardware components, any other processing unit, or any combination or multiplicity thereof. The processor 310 can be a single processing unit, multiple processing units, a single processing core, multiple processing cores, special purpose processing cores, co-processors, or any combination thereof. According to certain embodiments, the processor 310 along with other components of the computing machine 300 can be a software based or hardware based virtualized computing machine executing within one or more other computing machines.

The system memory 330 can include non-volatile memories such as read-only memory (“ROM”), programmable read-only memory (“PROM”), erasable programmable read-only memory (“EPROM”), flash memory, or any other device capable of storing program instructions or data with or without applied power. The system memory 330 can also include volatile memories such as random access memory (“RAM”), static random access memory (“SRAM”), dynamic random access memory (“DRAM”), and synchronous dynamic random access memory (“SDRAM”). Other types of RAM also can be used to implement the system memory 330. The system memory 330 can be implemented using a single memory module or multiple memory modules. While the system memory 330 is depicted as being part of the computing machine, one skilled in the art will recognize that the system memory 330 can be separate from the computing machine 300 without departing from the scope of the subject technology. It should also be appreciated that the system memory 330 can include, or operate in conjunction with, a non-volatile storage device such as the storage media 340.

The storage media 340 can include a hard disk, a floppy disk, a compact disc read-only memory (“CD-ROM”), a digital versatile disc (“DVD”), a Blu-ray disc, a magnetic tape, a flash memory, other non-volatile memory device, a solid state drive (“SSD”), any magnetic storage device, any optical storage device, any electrical storage device, any semiconductor storage device, any physical-based storage device, any other data storage device, or any combination or multiplicity thereof. The storage media 340 can store one or more operating systems, application programs and program modules, data, or any other information. The storage media 340 can be part of, or connected to, the computing machine. The storage media 340 can also be part of one or more other computing machines that are in communication with the computing machine such as servers, database servers, cloud storage, network attached storage, and so forth.

The applications module 400 and other OS application modules can comprise one or more hardware or software elements configured to facilitate the computing machine with performing the various methods and processing functions presented herein. The applications module 400 and other OS application modules can include one or more algorithms or sequences of instructions stored as software or firmware in association with the system memory 330, the storage media 340 or both. The storage media 340 can therefore represent examples of machine or computer readable media on which instructions or code can be stored for execution by the processor 310. Machine or computer readable media can generally refer to any medium or media used to provide instructions to the processor 310. Such machine or computer readable media associated with the applications module 400 and other OS application modules can comprise a computer software product. It should be appreciated that a computer software product comprising the applications module 400 and other OS application modules can also be associated with one or more processes or methods for delivering the applications module 400 and other OS application modules to the computing machine via a network, any signal-bearing medium, or any other communication or delivery technology. The applications module 400 and other OS application modules can also comprise hardware circuits or information for configuring hardware circuits such as microcode or configuration information for an FPGA or other PLD. In one exemplary embodiment, applications module 400 and other OS application modules can include algorithms capable of performing the functional operations described by the flow charts and computer systems presented herein.

The input/output (“I/O”) interface 350 can be configured to couple to one or more external devices, to receive data from the one or more external devices, and to send data to the one or more external devices. Such external devices along with the various internal devices can also be known as peripheral devices. The I/O interface 350 can include both electrical and physical connections for coupling the various peripheral devices to the computing machine or the processor 310. The I/O interface 350 can be configured to communicate data, addresses, and control signals between the peripheral devices, the computing machine, or the processor 310. The I/O interface 350 can be configured to implement any standard interface, such as small computer system interface (“SCSI”), serial-attached SCSI (“SAS”), fiber channel, peripheral component interconnect (“PCP”), PCI express (PCIe), serial bus, parallel bus, advanced technology attached (“ATA”), serial ATA (“SATA”), universal serial bus (“USB”), Thunderbolt, FireWire, various video buses, and the like. The I/O interface 350 can be configured to implement only one interface or bus technology. Alternatively, the I/O interface 350 can be configured to implement multiple interfaces or bus technologies. The I/O interface 350 can be configured as part of, all of, or to operate in conjunction with, the system bus 320. The I/O interface 350 can include one or more buffers for buffering transmissions between one or more external devices, internal devices, the computing machine, or the processor 320.

The I/O interface 320 can couple the computing machine to various input devices including mice, touch-screens, scanners, electronic digitizers, sensors, receivers, touchpads, trackballs, cameras, microphones, keyboards, any other pointing devices, or any combinations thereof. The I/O interface 320 can couple the computing machine to various output devices including video displays, speakers, printers, projectors, tactile feedback devices, automation control, robotic components, actuators, motors, fans, solenoids, valves, pumps, transmitters, signal emitters, lights, and so forth.

The computing machine 300 can operate in a networked environment using logical connections through the network interface 360 to one or more other systems or computing machines across a network. The network can include wide area networks (WAN), local area networks (LAN), intranets, the Internet, wireless access networks, wired networks, mobile networks, telephone networks, optical networks, or combinations thereof. The network can be packet switched, circuit switched, of any topology, and can use any communication protocol. Communication links within the network can involve various digital or an analog communication media such as fiber optic cables, free-space optics, waveguides, electrical conductors, wireless links, antennas, radio-frequency communications, and so forth.

The sensors 380 and controllers 390 can be components of field device components 18, i.e. surface and sub-surface sensors, configured to sense various physical properties, i.e. mechanical, chemical, and electrical properties, of surface sub-surface downhole machines and surrounding environment and communicate sensed data to the sensor hub 20.

The processor 310 can be connected to the other elements of the computing machine or the various peripherals discussed herein through the system bus 320. It should be appreciated that the system bus 320 can be within the processor 310, outside the processor 310, or both. According to some embodiments, any of the processors 310, the other elements of the computing machine, or the various peripherals discussed herein can be integrated into a single device such as a system on chip (“SOC”), system on package (“SOP”), or ASIC device.

Embodiments may comprise a computer program that embodies the functions described and illustrated herein, wherein the computer program is implemented in a computer system that comprises instructions stored in a machine-readable medium and a processor that executes the instructions. However, it should be apparent that there could be many different ways of implementing embodiments in computer programming, and the embodiments should not be construed as limited to any one set of computer program instructions unless otherwise disclosed for an exemplary embodiment. Further, a skilled programmer would be able to write such a computer program to implement an embodiment of the disclosed embodiments based on the appended flow charts, algorithms and associated description in the application text. Therefore, disclosure of a particular set of program code instructions is not considered necessary for an adequate understanding of how to make and use embodiments. Further, those skilled in the art will appreciate that one or more aspects of embodiments described herein may be performed by hardware, software, or a combination thereof, as may be embodied in one or more computing systems. Moreover, any reference to an act being performed by a computer should not be construed as being performed by a single computer as more than one computer may perform the act.

The example embodiments described herein can be used with computer hardware and software that perform the methods and processing functions described previously. The systems, methods, and procedures described herein can be embodied in a programmable computer, computer-executable software, or digital circuitry. The software can be stored on computer-readable media. For example, computer-readable media can include a floppy disk, RAM, ROM, hard disk, removable media, flash memory, memory stick, optical media, magneto-optical media, CD-ROM, etc. Digital circuitry can include integrated circuits, gate arrays, building block logic, field programmable gate arrays (FPGA), etc.

The example systems, methods, and acts described in the embodiments presented previously are illustrative, and, in alternative embodiments, certain acts can be performed in a different order, in parallel with one another, omitted entirely, and/or combined between different example embodiments, and/or certain additional acts can be performed, without departing from the scope and spirit of various embodiments. Accordingly, such alternative embodiments are included in the description herein.

As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items. As used herein, phrases such as “between X and Y” and “between about X and Y” should be interpreted to include X and Y. As used herein, phrases such as “between about X and Y” mean “between about X and about Y.” As used herein, phrases such as “from about X to Y” mean “from about X to about Y.”

As used herein, “hardware” can include a combination of discrete components, an integrated circuit, an application-specific integrated circuit, a field programmable gate array, or other suitable hardware. As used herein, “software” can include one or more objects, agents, threads, lines of code, subroutines, separate software applications, two or more lines of code or other suitable software structures operating in two or more software applications, on one or more processors (where a processor includes one or more microcomputers or other suitable data processing units, memory devices, input-output devices, displays, data input devices such as a keyboard or a mouse, peripherals such as printers and speakers, associated drivers, control cards, power sources, network devices, docking station devices, or other suitable devices operating under control of software systems in conjunction with the processor or other devices), or other suitable software structures. In one exemplary embodiment, software can include one or more lines of code or other suitable software structures operating in a general purpose software application, such as an operating system, and one or more lines of code or other suitable software structures operating in a specific purpose software application. As used herein, the term “couple” and its cognate terms, such as “couples” and “coupled,” can include a physical connection (such as a copper conductor), a virtual connection (such as through randomly assigned memory locations of a data memory device), a logical connection (such as through logical gates of a semiconducting device), other suitable connections, or a suitable combination of such connections. The term “data” can refer to a suitable structure for using, conveying or storing data, such as a data field, a data buffer, a data message having the data value and sender/receiver address data, a control message having the data value and one or more operators that cause the receiving system or component to perform a function using the data, or other suitable hardware or software components for the electronic processing of data.

In general, a software system is a system that operates on a processor to perform predetermined functions in response to predetermined data fields. For example, a system can be defined by the function it performs and the data fields that it performs the function on. As used herein, a NAME system, where NAME is typically the name of the general function that is performed by the system, refers to a software system that is configured to operate on a processor and to perform the disclosed function on the disclosed data fields. Unless a specific algorithm is disclosed, then any suitable algorithm that would be known to one of skill in the art for performing the function using the associated data fields is contemplated as falling within the scope of the disclosure. For example, a message system that generates a message that includes a sender address field, a recipient address field and a message field would encompass software operating on a processor that can obtain the sender address field, recipient address field and message field from a suitable system or device of the processor, such as a buffer device or buffer system, can assemble the sender address field, recipient address field and message field into a suitable electronic message format (such as an electronic mail message, a TCP/IP message or any other suitable message format that has a sender address field, a recipient address field and message field), and can transmit the electronic message using electronic messaging systems and devices of the processor over a communications medium, such as a network. One of ordinary skill in the art would be able to provide the specific coding for a specific application based on the foregoing disclosure, which is intended to set forth exemplary embodiments of the present disclosure, and not to provide a tutorial for someone having less than ordinary skill in the art, such as someone who is unfamiliar with programming or processors in a suitable programming language. A specific algorithm for performing a function can be provided in a flow chart form or in other suitable formats, where the data fields and associated functions can be set forth in an exemplary order of operations, where the order can be rearranged as suitable and is not intended to be limiting unless explicitly stated to be limiting.

The above-disclosed embodiments have been presented for purposes of illustration and to enable one of ordinary skill in the art to practice the disclosure, but the disclosure is not intended to be exhaustive or limited to the forms disclosed. Many insubstantial modifications and variations will be apparent to those of ordinary skill in the art without departing from the scope and spirit of the disclosure. The scope of the claims is intended to broadly cover the disclosed embodiments and any such modification. Further, the following clauses represent additional embodiments of the disclosure and should be considered within the scope of the disclosure:

Clause 1, a system for controlling operations of a drill in a downhole well environment, the system comprising: a sensor hub configured to communicate with a plurality of surface sensors and sub-surface sensors; a predictive engine configured to receive a plurality of variables associated with the plurality of surface sensors and sub-surface sensors from the sensor hub, the predictive engine further configured to predict an earth model based on the plurality of variables and predict at least one drill path ahead of the drill based on the predicted earth model and at least one drilling model; and a controller configured to generate at least one system response based on the predicted at least one drill path and a current state of the drill;

Clause 2, the system of clause 1, wherein the plurality of variables are well log data variables and seismic data variables;

Clause 3, the system of clause 2, wherein the well log data variables and the seismic data variables comprises at least one of current drilling coordinates, production equipment measurements, rig sensing and control, fluids and additive measurements, cementing measurements and controls, wireline and perforations sense and control, telemetry, surface measurements, downhole measurements, rotary steerable electronic bit, and earth physical properties data;

Clause 4, the system of clause 1, wherein the predictive engine comprises an artificial intelligence engine configured to predict the earth model based on the plurality of variables and at least one predictor variable, at least one outcome variable, and relationships between the predictor variables and the at least one outcome variable;

Clause 5, the system of clause 1, wherein the artificial intelligence engine further comprises a data filter component configured to clean the plurality of variables;

Clause 6, the system of clause 5, wherein the data filter component is further configured to clean the plurality of variables using the predicted earth model;

Clause 7, the system of clause 1, wherein the predictive engine further comprises an optimization engine configured to predict the at least one drill path using stochastic modeling, at least one outcome variable, the predicted earth model, and the at least one drilling model;

Clause 8, the system of claim 1, wherein the predictive engine further comprises a machine learning engine configured to store the earth model, the at least one drill path, and the plurality of variables and use a machine learning algorithm to train data and create drilling models based on the trained data;

Clause 9, the system of clause 8, wherein at least one of the earth model, the at least one drill path, the plurality of variables, and the drilling models are stored in a secure, distributed storage network;

Clause 10, the system of clause 1, wherein the controller is further configured to: generate a visualization of probable distribution of the predicted at least one drill path; and issue at least one action causing an adjustment to the current state of the drill path based on the predicted at least one drill path;

Clause 11, A non-transitory machine-readable storage medium, comprising instructions, which when executed by a machine, causes the machine to perform operations comprising: communicable coupling a sensor hub with a plurality of surface sensors and sub-surface sensors; receiving a plurality of variables associated with the plurality of surface sensors and sub-surface sensors from the sensor hub; predicting an earth model based on the plurality of variables; predicting at least one drill path ahead of the drill based on the predicted earth model and at least one drilling model; and generating at least one system response based on the predicted at least one drill path and a current state of the drill;

Clause 12, the non-transitory machine-readable storage medium of clause 11, wherein the plurality of variables are well log data variables and seismic data variables;

Clause 13, the non-transitory machine-readable storage medium of clause 11, wherein the earth model is predicted based on the plurality of variables and at least one predictor variable, at least one outcome variable, and relationships between the predictor variables and the at least one outcome variable;

Clause 14, the non-transitory machine-readable storage medium of clause 13, wherein the operations further comprise: cleaning the plurality of variables using the predicted earth model;

Clause 15, the non-transitory machine-readable storage medium of clause 11, wherein the at least one drill path is predicted using stochastic modeling, at least one outcome variable, the predicted earth model, and the at least one drilling model;

Clause 16, the non-transitory machine-readable storage medium of clause 11, wherein the operations further comprise: storing the earth model, the at least one drill path, and the plurality of variables; and using a machine learning algorithm to train data and create drilling models based on the trained data; wherein at least one of the earth model, the at least one drill path, the plurality of variables, and the drilling models are stored in a secure, distributed storage network;

Clause 17, a method for controlling operations of a drill in a downhole well environment, the method comprising: communicable coupling a sensor hub with a plurality of surface sensors and sub-surface sensors; receiving a plurality of variables associated with the plurality of surface sensors and sub-surface sensors from the sensor hub; predicting an earth model based on the plurality of variables; predicting at least one drill path ahead of the drill based on the predicted earth model and at least one drilling model; and generating at least one system response based on the predicted at least one drill path and a current state of the drill;

Clause 18, the method of clause 17, wherein the earth model is predicted based on the plurality of variables and at least one predictor variable, at least one outcome variable, and relationships between the predictor variables and the at least one outcome variable;

Clause 19, the method of clause 17, wherein the at least one drill path is predicted using stochastic modeling, at least one outcome variable, the predicted earth model, and the at least one drilling model;

Clause 20, the method of clause 17, further comprising: cleaning the plurality of variables using the predicted earth model; storing the earth model, the at least one drill path, and the plurality of variables; and using a machine learning algorithm to train data and create drilling models based on the trained data; wherein at least one of the earth model, the at least one drill path, the plurality of variables, and the drilling models are stored in a secure, distributed storage network.

What is claimed is:

1. A system for controlling operations of a drill in a downhole well environment, the system comprising:
a sensor hub configured to communicate with a plurality of surface sensors and sub-surface sensors;
a predictive engine configured to receive a plurality of variables associated with the plurality of surface sensors and sub-surface sensors from the sensor hub, the predictive engine further configured to predict an earth model based on the plurality of variables and predict at least one drill path ahead of the drill based on the predicted earth model and at least one drilling model; and
a controller configured to generate at least one system response based on the predicted at least one drill path and a current state of the drill.

2. The system of claim 1, wherein the plurality of variables are well log data variables and seismic data variables.

3. The system of claim 2, wherein the well log data variables and the seismic data variables comprises at least one of current drilling coordinates, production equipment measurements, rig sensing and control, fluids and additive measurements, cementing measurements and controls, wireline and perforations sense and control, telemetry, surface measurements, downhole measurements, rotary steerable electronic bit, and earth physical properties data.

4. The system of claim 1, wherein the predictive engine comprises an artificial intelligence engine configured to predict the earth model based on the plurality of variables and at least one predictor variable, at least one outcome variable, and relationships between the predictor variables and the at least one outcome variable.

5. The system of claim 4, wherein the artificial intelligence engine further comprises a data filter component configured to clean the plurality of variables.

6. The system of claim 5, wherein the data filter component is further configured to clean the plurality of variables using the predicted earth model.

7. The system of claim 1, wherein the predictive engine further comprises an optimization engine configured to predict the at least one drill path using stochastic modeling, at least one outcome variable, the predicted earth model, and the at least one drilling model.

8. The system of claim 1, wherein the predictive engine further comprises a machine learning engine configured to store the earth model, the at least one drill path, and the plurality of variables and use a machine learning algorithm to train data and create drilling models based on the trained data.

9. The system of claim 8, wherein at least one of the earth model, the at least one drill path, the plurality of variables, and the drilling models are stored in a secure, distributed storage network.

10. The system of claim 1, wherein the controller is further configured to:
generate a visualization of probable distribution of the predicted at least one drill path; and
issue at least one action causing an adjustment to the current state of the drill path based on the predicted at least one drill path.

11. A non-transitory machine-readable storage medium, comprising instructions, which when executed by a machine, causes the machine to perform operations comprising:
communicable coupling a sensor hub with a plurality of surface sensors and sub-surface sensors;
receiving a plurality of variables associated with the plurality of surface sensors and sub-surface sensors from the sensor hub;
predicting an earth model based on the plurality of variables;
predicting at least one drill path ahead of the drill based on the predicted earth model and at least one drilling model; and
generating at least one system response based on the predicted at least one drill path and a current state of the drill.

12. The non-transitory machine-readable storage medium of claim 11, wherein the plurality of variables are well log data variables and seismic data variables.

13. The non-transitory machine-readable storage medium of claim 11, wherein the earth model is predicted based on the plurality of variables and at least one predictor variable, at least one outcome variable, and relationships between the predictor variables and the at least one outcome variable.

14. The non-transitory machine-readable storage medium of claim 13, wherein the operations further comprise: cleaning the plurality of variables using the predicted earth model.

15. The non-transitory machine-readable storage medium of claim 11, wherein the at least one drill path is predicted using stochastic modeling, at least one outcome variable, the predicted earth model, and the at least one drilling model.

16. The non-transitory machine-readable storage medium of claim 11, wherein the operations further comprise:
storing the earth model, the at least one drill path, and the plurality of variables; and
using a machine learning algorithm to train data and create drilling models based on the trained data;
wherein at least one of the earth model, the at least one drill path, the plurality of variables, and the drilling models are stored in a secure, distributed storage network.

17. A method for controlling operations of a drill in a downhole well environment, the method comprising:
communicable coupling a sensor hub with a plurality of surface sensors and sub-surface sensors;
receiving a plurality of variables associated with the plurality of surface sensors and sub-surface sensors from the sensor hub;
predicting an earth model based on the plurality of variables;
predicting at least one drill path ahead of the drill based on the predicted earth model and at least one drilling model; and
generating at least one system response based on the predicted at least one drill path and a current state of the drill.

18. The method of claim 17, wherein the earth model is predicted based on the plurality of variables and at least one predictor variable, at least one outcome variable, and relationships between the predictor variables and the at least one outcome variable.

19. The method of claim 17, wherein the at least one drill path is predicted using stochastic modeling, at least one outcome variable, the predicted earth model, and the at least one drilling model.

20. The method of claim 17, further comprising:
cleaning the plurality of variables using the predicted earth model;
storing the earth model, the at least one drill path, and the plurality of variables; and
using a machine learning algorithm to train data and create drilling models based on the trained data;
wherein at least one of the earth model, the at least one drill path, the plurality of variables, and the drilling models are stored in a secure, distributed storage network.
